(19) United States
(12) Patent Application Publication
(10) Pub. No.: US 2026/0246908 A1
(43) Pub. Date: Aug. 20, 2026

(54) ELECTRONIC DEVICE

(71) Applicant: CANON KABUSHIKI KAISHA, Tokyo (JP)

(72) Inventor: Hiroyuki SUZUKI, Kanagawa (JP)

(21) Appl. No.: 19/434,339

(22) Filed: Dec. 29, 2025

(30) Foreign Application Priority Data
Feb. 18, 2025 (JP) 2025-024362

(51) Int. Cl. H04N 13/296; H04N 13/207; H04N 13/398; H04N 23/67

(52) U.S. Cl. CPC H04N 13/296; H04N 13/207; H04N 13/398; H04N 23/675

(57) ABSTRACT

An electronic device acquires a first image area captured via a first optical system and a second image area captured via a second optical system, detects a same object from the first and second image areas, acquires a first focusing degree that is a focusing degree of the object in the first image area and a second focusing degree that is a focusing degree of the object in the second image area, and in a case where a difference between the first and second focusing degrees is larger than a predetermined threshold, controls driving states of the first and second optical systems from a first state in which the first and second optical systems are able to be driven to a second state in which only one of the first and second optical systems is able to be driven.

### BACKGROUND

### Field of the Technology

The present disclosure relates to an electronic device, and particularly to focus control.

### Description of the Related Art

An imaging apparatus that captures two images having parallax using two optical systems has been proposed. In order to generate an image capable of excellent stereoscopic viewing from the two images obtained by the imaging apparatus, it is necessary that the two images have the same focusing degree. Therefore, it is necessary to perform focus control of the two optical systems, but it is inefficient to perform focus control of each of the two optical systems.

Japanese Patent Laid-Open No. 2013-109079 discloses a technology for adjusting a relative position of a focus evaluation area in one of two images and a relative position of a focus evaluation area in the other of the two images based on a separation distance between two optical systems. In the technology disclosed in Japanese Patent Laid-Open No. 2013-109079, two optical systems are individually driven.

However, even if the technology disclosed in Japanese Patent Laid-Open No. 2013-109079 is used, an image difficult to be stereoscopically viewed is generated from the two captured images, and there is a risk that user experience is impaired.

### SUMMARY

The present disclosure provides a technology capable of reducing the possibility of generating an image that is difficult to stereoscopically view and improving user experience.

An electronic device according to the present disclosure includes a processor, and a memory storing a program which, when executed by the processor, causes the electronic device to execute first acquisition processing of acquiring a first image area captured via a first optical system and a second image area captured via a second optical system, execute detection processing of detecting a same object from the first image area and the second image area, execute second acquisition processing of acquiring a first focusing degree that is a focusing degree of the object in the first image area and a second focusing degree that is a focusing degree of the object in the second image area, and execute, in a case where a difference between the first focusing degree and the second focusing degree is larger than a predetermined threshold, control processing of controlling driving states of the first optical system and the second optical system from a first state in which the first optical system and the second optical system are able to be driven to a second state in which only one of the first optical system and the second optical system is able to be driven.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views of a camera.

FIG. 2 is a block diagram of the camera.

FIG. 3 is a schematic diagram of a lens unit.

FIG. 4 is a flowchart of a camera operation.

FIG. 5 is a flowchart of a camera operation.

FIG. 6 is a schematic diagram of a setting screen.

FIGS. 7A and 7B are schematic diagrams of a shooting standby screen.

### DESCRIPTION OF THE EMBODIMENTS

Hereinafter, embodiments of the present disclosure will be described with reference to the accompanying drawings.

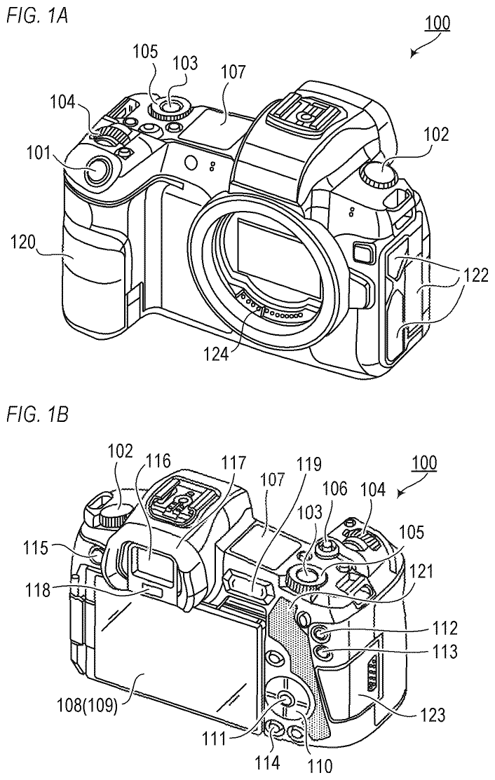

FIGS. 1A and 1B are external views illustrating an example of an external appearance of a digital camera (camera) 100 according to the present embodiment. FIG. 1A is a perspective view of the camera 100 as viewed from a front side, and FIG. 1B is a perspective view of the camera 100 as viewed from a back surface.

The camera 100 includes, on an upper surface thereof, a shutter button 101, a power switch 102, a mode selector switch 103, a main electronic dial 104, a sub-electronic dial 105, a moving image button 106, and an outside viewfinder display unit 107. The shutter button 101 is an operation member for providing a shooting preparation instruction or a shooting instruction. The power switch 102 is an operation member for switching on or off of a power supply of the camera 100. The mode selector switch 103 is an operation member for switching among various modes. The main electronic dial 104 is a rotary operation member for changing setting values such as a shutter speed and an aperture value. The sub-electronic dial 105 is a rotary operation member for moving a selection frame (cursor) and feeding images. The moving image button 106 is an operation member for providing an instruction to start or stop movie shooting (recording). The outside viewfinder display unit 107 displays various setting values such as a shutter speed and an aperture value.

The camera 100 includes, on a back surface, a display unit 108, a touch panel 109, a direction key 110, a SET button 111, an AE lock button 112, an enlargement button 113, a playback button 114, a menu button 115, an eyepiece portion 116, an eyepiece detection unit 118, and a touch bar 119. The display unit 108 displays images and various types of information. The touch panel 109 is an operation member for detecting a touch operation on a display surface (touch operation surface) of the display unit 108. The direction key 110 is an operation unit (four direction key) configured with keys that can be pressed up, down, left, and right (four keys). Processing corresponding to a position where the direction key 110 is pressed can be performed. The SET button 111 is an operation member to be pressed mainly when a selected item is determined. The AE lock button 112 is an operation member to be pressed when an exposure state is fixed in a shooting standby state. The enlargement button 113 is an operation member for switching on or off an enlargement mode in live view display (LV display) of a shooting mode. In a case where the enlargement mode is switched on, a live view image (LV image) is enlarged or reduced by operating the main electronic dial 104. In addition, the enlargement button 113 is used for enlarging a playback image or increasing an enlargement ratio in a playback mode. The playback button 114 is an operation member for switching between the shooting mode and the playback mode. In case of the shooting mode, according to the press of the playback button 114, the mode shifts to the playback mode, and thus, it is possible to display a latest image of images recorded in a recording medium 227 to be described below on the display unit 108.

The menu button 115 is an operation member to be pressed for displaying a menu screen, which enables various settings, on the display unit 108. A user can perform various settings instinctively by using the menu screen displayed in the display unit 108, the direction key 110, and the SET button 111. The eyepiece portion 116 is a portion in which the user approaches and looks through an eyepiece viewfinder (looking-through type viewfinder) 117 with the eyes. The user can visually recognize an image displayed in an EVF 217 (Electronic View Finder) described below which is positioned inside the camera 100 via the eyepiece portion 116. The eyepiece detection unit 118 is a sensor which detects whether the user approaches the eyepiece portion 116 (the eyepiece viewfinder 117) with the eyes.

The touch bar 119 is a linear touch operation member (line touch sensor) that can receive a touch operation. The touch bar 119 is disposed at a position that enables a touch operation (touchable) with the thumb finger of the right hand in a state where a grip portion 120 is gripped with the right hand (a state where the grip portion 120 is gripped with the little finger, the ring finger, and the middle finger of the right hand) such that the shutter button 101 can be pressed by the index finger of the right hand. That is, the touch bar 119 can be operated in a state where the user approaches to the eyepiece viewfinder 117 with the eyes, looks through the eyepiece portion 116, and holds up the camera 100 so as to be able to press the shutter button 101 at any time (shooting orientation). The touch bar 119 can receive a tapping operation on the touch bar 119 (an operation of touching the touch bar and releasing the touch bar without moving a touch position within a predetermined period of time), a sliding operation to the left or right (an operation of touching the touch bar and then moving the touch position while keeping the touch), and the like. The touch bar 119 is an operation member that is different from the touch panel 109 and does not have a display function. The touch bar 119 functions as, for example, a multi-function bar (M-Fn bar) to which various functions can be allocated.

In addition, the camera 100 has a grip portion 120, a thumb rest portion 121, a terminal cover 122, a lid 123, a communication terminal 124, and the like. The grip portion 120 is a holding portion which is formed into a shape in which the user can easily grip with the right hand when holding up the camera 100. The shutter button 101 and the main electronic dial 104 are arranged at positions where the user can operate the shutter button 101 and the main electronic dial 104 with the index finger of the right hand in a state in which the user holds the camera 100 while gripping the grip portion 120 with the little finger, the ring finger, and the middle finger of the right hand. In addition, in a similar state, the sub-electronic dial 105 and the touch bar 119 are arranged at positions where the user can operate the sub-electronic dial 105 and the touch bar 119 with the thumb finger of the right hand. The thumb rest portion 121 (thumb standby position) is a grip portion provided at a place where it is easy for the user to place the thumb finger of the right hand that grips the grip portion 120 on the back surface of the camera 100 in a state where any of the operation members is not operated. The thumb rest portion 121 is configured with a rubber member for enhancing holding power (gripping feeling). The terminal cover 122 protects connectors such as connection cables for connecting the camera 100 to external devices (external equipment). The lid 123 closes a slot for storing the recording medium 227 to be described below, to protect the recording medium 227 and the slot. The communication terminal 124 is a terminal for communication with a lens unit (a lens unit 200, a lens unit 300, or the like to be described below) attachable to and detachable from the camera 100.

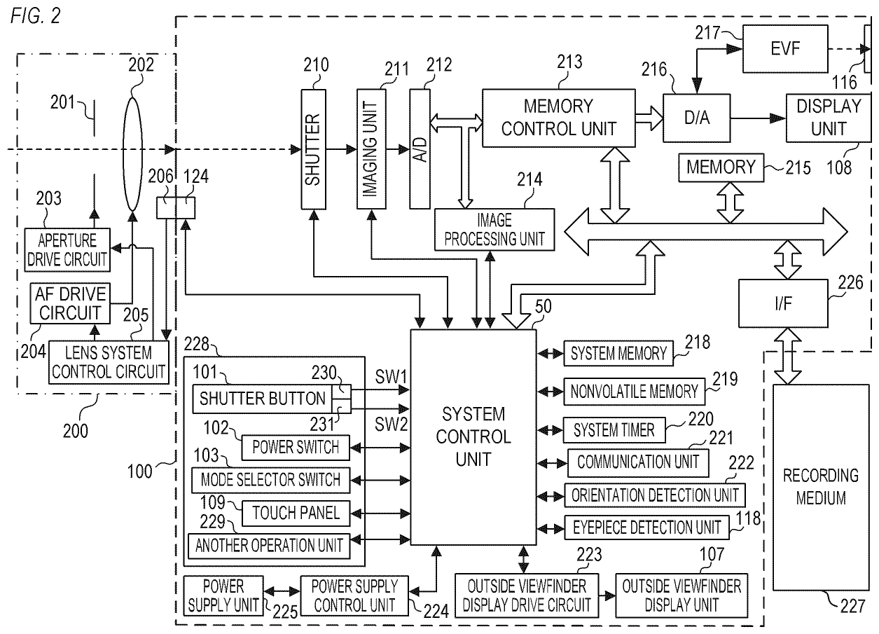

FIG. 2 is a block diagram illustrating an example of a configuration of the camera 100. Note that, in FIG. 2, the same components as those in FIGS. 1A and 1B are denoted by the same reference numerals as in FIGS. 1A and 1B, and description of the components is appropriately omitted. In FIG. 2, the lens unit 200 is mounted to the camera 100.

First, the lens unit 200 will be described. The lens unit 200 is a type of an interchangeable lens unit (interchangeable lens) that is attachable to and detachable from the camera 100. The lens unit 200 is a single-lens unit (single lens) and is an example of a normal lens unit. The lens unit 200 includes an aperture 201, a lens 202, an aperture drive circuit 203, an autofocus (AF) drive circuit 204, a lens system control circuit 205, a communication terminal 206, and the like.

The aperture 201 is configured so that an aperture diameter is adjustable. The lens 202 is configured with a plurality of lenses. The aperture drive circuit 203 adjusts a quantity of light by controlling the aperture diameter of the aperture 201. The AF drive circuit 204 adjusts the focus by driving the lens 202. The lens system control circuit 205 controls the aperture drive circuit 203, the AF drive circuit 204, and the like based on instructions from a system control unit 50 to be described below. The lens system control circuit 205 controls the aperture 201 via the aperture drive circuit 203 and adjusts the focus by changing a position of the lens 202 via the AF drive circuit 204. The lens system control circuit 205 can communicate with the camera 100. Specifically, communication is performed via the communication terminal 206 of the lens unit 200 and the communication terminal 124 of the camera 100. The communication terminal 206 is a terminal for the lens unit 200 to communicate with the camera 100 side.

Next, the camera 100 is described. The camera 100 includes a shutter 210, an imaging unit 211, an A/D converter 212, a memory control unit 213, an image processing unit 214, a memory 215, a D/A converter 216, the EVF 217, the display unit 108, and the system control unit 50.

The shutter 210 is a focal plane shutter that can freely control an exposure time of the imaging unit 211 based on an instruction of the system control unit 50. The imaging unit 211 is an imaging element (image sensor) configured with a CCD, a CMOS element, or the like that converts an optical image into an electrical signal. The imaging unit 211 may include an imaging-surface phase-difference sensor that outputs defocus amount information to the system control unit 50. The A/D converter 212 converts an analog signal output from the imaging unit 211 into a digital signal. The image processing unit 214 performs predetermined processing (pixel interpolation, resizing processing such as reduction, color conversion processing, and the like) on data from the A/D converter 212 or data from the memory control unit 213. In addition, the image processing unit 214 performs predetermined arithmetic processing by using captured image data, and the system control unit 50 performs exposure control and distance measurement control based on the obtained result of arithmetic processing. By this processing, through-the-lens (TTL)-type AF processing, auto exposure (AE) processing, EF (flash pre-flash) processing, and the like are performed. Furthermore, the image processing unit 214 performs predetermined arithmetic processing by using the captured image data, and the system control unit 50 performs TTL-type auto white balance (AWB) processing based on the obtained result of arithmetic processing.

The image data from the A/D converter 212 is written into the memory 215 via the image processing unit 214 and the memory control unit 213. Alternatively, the image data from the A/D converter 212 is written into the memory 215 via the memory control unit 213 without the intervention of the image processing unit 214. The memory 215 stores the image data that is obtained by the imaging unit 211 and is converted into digital data by the A/D converter 212 and image data to be displayed on the display unit 108 or the EVF 217. The memory 215 has a storage capacity sufficient to store a predetermined number of still images and a predetermined length of moving images and voice. In addition, the memory 215 also serves as a memory for displaying an image (video memory).

The D/A converter 216 converts image data for display stored in the memory 215 into an analog signal and supplies the analog signal to the display unit 108 or the EVF 217. Accordingly, the image data for display written into the memory 215 is displayed on the display unit 108 or the EVF 217 via the D/A converter 216. The display unit 108 and the EVF 217 provide display in response to the analog signal from the D/A converter 216. The display unit 108 and the EVF 217 are, for example, LCD or organic EL displays. The digital signal that is A/D converted by the A/D converter 212 and is accumulated in the memory 215 is converted into the analog signal in the D/A converter 216, and the analog signal is sequentially transferred to and displayed on the display unit 108 or the EVF 217, so that live-view display is performed.

The system control unit 50 is a control unit including at least one processor and/or at least one circuit. That is, the system control unit 50 may be a processor, a circuit, or a combination of a processor and a circuit. The system control unit 50 controls the overall camera 100. The system control unit 50 executes a program recorded in a nonvolatile memory 219 to implement each processing of a flowchart to be described later. The system control unit 50 also performs display control by controlling the memory 215, the D/A converter 216, the display unit 108, the EVF 217, and the like.

In addition, the camera 100 includes a system memory 218, a nonvolatile memory 219, a system timer 220, a communication unit 221, an orientation detection unit 222, and an eyepiece detection unit 118.

For example, a RAM is used as the system memory 218. In the system memory 218, constants, variables, and programs read from the nonvolatile memory 219 for an operation of the system control unit 50 are loaded. The nonvolatile memory 219 is an electrically erasable and recordable memory. For example, an EEPROM is used as the nonvolatile memory 219. In the nonvolatile memory 219, constants, programs, and the like for the operation of the system control unit 50 are recorded. The program as used herein includes programs for performing the flowcharts to be described below. The system timer 220 is a timer unit that counts time used for various controls and time of an embedded clock. The communication unit 221 transmits and receives a video signal and a voice signal to and from external device connected wirelessly or via a wired cable. The communication unit 221 is also connectable to a wireless local area network (LAN) and the Internet. In addition, the communication unit 221 can communicate with external device also via Bluetooth (registered trademark) and Bluetooth Low Energy. The communication unit 221 can transmit an image captured by the imaging unit 211 (including a live image) and an image recorded in the recording medium 227 and can receive an image and other various types of information from external device. The orientation detection unit 222 is an orientation detection sensor that detects an orientation of the camera 100 with respect to a direction of gravity. Based on the orientation detected by the orientation detection unit 222, whether an image shot by the imaging unit 211 is an image shot with the camera 100 held in a horizontal position or held in a vertical position can be determined. The system control unit 50 can add orientation information in accordance with the orientation detected by the orientation detection unit 222 to an image file of the image shot by the imaging unit 211 and can rotate the image corresponding to the detected orientation. For example, an acceleration sensor or a gyro sensor can be used for the orientation detection unit 222. It is possible to also detect the movement of the camera 100 (whether it is panning, tilting, lifting, stationary, or the like) by using the orientation detection unit 222.

The eyepiece detection unit 118 can detect that an object approaches the eyepiece portion 116 (eyepiece viewfinder 117). For example, an infrared proximity sensor can be used as the eyepiece detection unit 118. In a case where the object approaches, infrared light emitted from a light-emitting portion of the eyepiece detection unit 118 is reflected on the object and is received by a light-receiving portion of the infrared proximity sensor. A distance from the eyepiece portion 116 to the object can be determined according to the amount of received infrared light. In this manner, the eyepiece detection unit 118 performs the eyepiece detection of detecting the proximity distance of the object to the eyepiece portion 116. The eyepiece detection unit 118 is an eyepiece detection sensor that detects approach (eye approach) and separation (eye separation) of an eye (object) to and from the eyepiece portion 116. In a case where an object approaching within a predetermined distance with respect to the eyepiece portion 116 from the non-eye contacting state (non-approaching state) is detected, it is detected that an eye approaches. Meanwhile, in a case where the object of which the approach is detected is separated by a predetermined distance or longer in an eye approach state (approach state), the eyepiece detection unit 118 detects that the eye is separated. A threshold for detecting the eye approach and a threshold for detecting the eye separation may be different for providing, for example, a hysteresis. In addition, after the eye approach is detected, the eye approach state is assumed until the eye separation is detected. After the eye separation is detected, the non-eye contacting state is assumed until the eye approach is detected. The system control unit 50 switches between display (display state) and non-display (non-display state) of each of the display unit 108 and the EVF 217 in accordance with the state detected by the eyepiece detection unit 118. Specifically, in a case where at least the shooting standby state is established, and a switching setting for a display destination is set to automatic switching, the display destination is set as the display unit 108, and the display is turned on, while the EVF 217 is set to non-display during the non-eye contacting state. In addition, during the eye approach state, the EVF 217 is set as the display destination, and the display is turned on, while the display unit 108 is set to non-display. Note that the eyepiece detection unit 118 is not limited to the infrared proximity sensor, and other sensors may be used as the eyepiece detection unit 118 as long as the sensors can detect the state which can be regarded as the eye approach.

Furthermore, the camera 100 includes an outside viewfinder display unit 107, an outside viewfinder display drive circuit 223, a power supply control unit 224, a power supply unit 225, a recording medium I/F 226, an operation unit 228, and the like.

The outside viewfinder display unit 107 is driven by the outside viewfinder display drive circuit 223 and displays various setting values for the camera 100 such as a shutter speed and an aperture value. The power supply control unit 224 is configured with a battery detection circuit, a DC-DC converter, a switch circuit that switches a block to be energized, and the like and detects whether a battery is mounted, a type of battery, a remaining battery level, and the like. In addition, the power supply control unit 224 controls the DC-DC converter based on the detection result and an instruction from the system control unit 50 and supplies a required voltage to portions including the recording medium 227 for a necessary period of time. The power supply unit 225 is a primary battery such as alkaline and lithium batteries, a secondary battery such as NiCd, NiMH, and Li batteries, an AC adapter, or the like. The recording medium I/F 226 is an interface to the recording medium 227 such as a memory card and a hard disk. The recording medium 227 is a memory card for recording shot images, and the like and is configured with a semiconductor memory, a magnetic disk, and the like. The recording medium 227 may be detachable from the camera 100 or may be built in the camera 100.

The operation unit 228 is an input unit which receives operations from the user (user operations), and is used for inputting various instructions to the system control unit 50. The operation unit 228 includes a shutter button 101, a power switch 102, a mode selector switch 103, a touch panel 109, another operation unit 229, and the like. The another operation unit 229 includes a main electronic dial 104, a sub-electronic dial 105, a moving image button 106, a direction key 110, a SET button 111, an AE lock button 112, an enlargement button 113, a playback button 114, a menu button 115, a touch bar 119, and the like.

The shutter button 101 includes a first shutter switch 230 and a second shutter switch 231. The first shutter switch 230 is turned on in the middle of the operation of the shutter button 101 in response to so-called half-press (shooting preparation instruction) and outputs a first shutter switch signal SW1. The system control unit 50 starts shooting preparation processing such as AF processing, AE processing, AWB processing, and EF processing in accordance with the first shutter switch signal SW1. The second shutter switch 231 is turned on at the completion of the operation of the shutter button 101 in response to so-called full-press (shooting instruction) and outputs a second shutter switch signal SW2. In accordance with the second shutter switch signal SW2, the system control unit 50 starts a sequence of shooting processing involving reading of a signal from the imaging unit 211, generating an image file including the shot image, and writing of the generated image file into the recording medium 227.

The mode selector switch 103 switches the operation mode of the system control unit 50 to any one of a still image shooting mode, a moving image shooting mode, a playback mode, and the like. Examples of the modes of the still image shooting mode include an auto shooting mode, an auto scene-determination mode, a manual mode, an aperture-priority mode (Av mode), a shutter-speed priority mode (Tv mode), and a program AE mode (P mode). Examples of the mode also include various scene modes which have shooting settings for different shooting scenes, a custom mode, and the like. The user can directly switch the operation mode to any of the above-described shooting modes with the mode selector switch 103. Alternatively, the user can once switch a screen to a list screen of the shooting modes with the mode selector switch 103 and then selectively switch the operation mode to any of a plurality of displayed modes by using the operation unit 228. Similarly, the moving image shooting mode may include a plurality of modes.

The touch panel 109 is a touch sensor that detects various touch operations on a display surface of the display unit 108 (an operation surface of the touch panel 109). The touch panel 109 and the display unit 108 can be integrally configured. For example, the touch panel 109 is attached to an upper layer of the display surface of the display unit 108 such that a transmittance of light does not hinder the display on the display unit 108. Input coordinates on the touch panel 109 and display coordinates on the display surface of the display unit 108 are associated with each other, thereby configuring a graphical user interface (GUI) such that the user can directly operate a screen displayed on the display unit 108. The touch panel 109 can use any of various methods including resistive film, capacitive, surface acoustic wave, infrared, electromagnetic induction, image recognition, optical sensor, and the like. Depending on the methods, there is a method of detecting a touch based on contact with the touch panel 109 and a method of detecting a touch based on approach of a finger or a pen to the touch panel 109, but any method may be adopted.

The system control unit 50 can detect the following operations or states on the touch panel 109.
An operation in which a finger or a pen that has not touched the touch panel 109 newly touches the touch panel 109, that is, a start of the touch (hereinafter, referred to as Touch-Down).
A state in which the finger or the pen is in contact with the touch panel 109 (hereinafter referred to as Touch-On).
An operation in which the finger or the pen is moving while being in contact with the touch panel 109 (hereinafter referred to as Touch-Move).
An operation in which the finger or the pen that is in contact with the touch panel 109 is separated from (released from) the touch panel 109, that is, an end of the touch (hereinafter referred to as Touch-Up).
A state in which nothing is in contact with the touch panel 109 (hereinafter referred to as Touch-Off).

When the touch-down is detected, the touch-on is detected at the same time. After the touch-down, the touch-on is continuously detected normally unless the touch-up is detected. Also, when the touch-move is detected, the touch-on is continuously detected. Even if the touch-on is detected, the touch-move is not detected as long as the touch position is not moved. After the touch-up of all the fingers and the pens that have touched the touch panel is detected, the state transitions to the touch-off.

These operations and states and the position coordinates of the finger or the pen that is in contact with the touch panel 109 are notified to the system control unit 50 through an internal bus. The system control unit 50 determines what kind of operation (touch operation) is performed on the touch panel 109, based on the notified information. With regard to the touch-move, a movement direction of the finger or the pen moving on the touch panel 109 can be determined for each vertical component and for each horizontal component on the touch panel 109, based on change of the position coordinates. When the touch-move for a predetermined distance or longer is detected, it is determined that a sliding operation is performed. An operation in which a finger is swiftly moved by a certain distance while being in contact with the touch panel 109 and is separated is referred to as a flick. In other words, the flick is an operation in which the finger is swiftly slid on the touch panel 109 so as to flick the touch panel 109. When the touch-move for a predetermined distance or longer at a predetermined speed or higher is detected, and then the touch-up is detected without change, it is determined that the flick is performed (it can be determined that the flick is performed subsequently to the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinching operation (or simply referred to as a pinch).

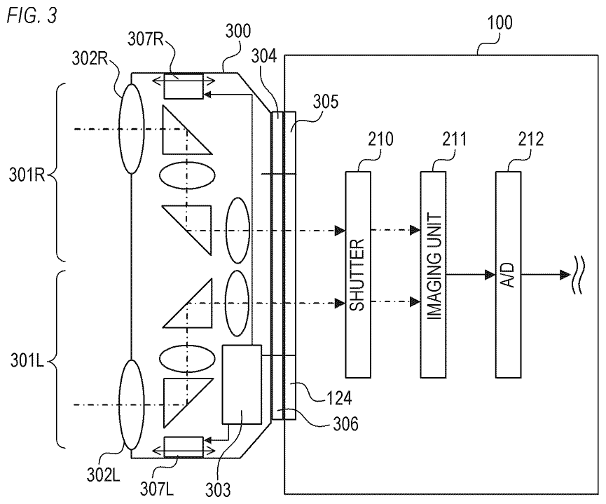

FIG. 3 is a schematic diagram illustrating an example of the configuration of the lens unit 300. FIG. 3 illustrates a state in which the lens unit 300 is mounted on the camera 100. In FIG. 3, the same components as those described in FIG. 2 are denoted by the same reference numerals as in FIG. 2, and the description thereof is appropriately omitted.

The lens unit 300 is a type of an interchangeable lens unit attachable to and detachable from the camera 100. The lens unit 300 is a dual-lens unit (dual lens) capable of capturing a right image and a left image having a parallax. The lens unit 300 includes two optical systems, and each of the two optical systems can capture an image in a range at a wide viewing angle of about 180 degrees. Specifically, each of the two optical systems of the lens unit 300 can capture an image of an object corresponding to a field of view (angle of view) of 180 degrees in a left-to-right direction (horizontal angle, azimuth angle, yaw angle) and 180 degrees in an up-and-down direction (vertical angle, elevation angle, pitch angle). That is, each of the two optical systems can capture an image in a front hemispherical range.

The lens unit 300 includes a right optical system 301R including a plurality of lenses, reflecting mirrors, and the like, a left optical system 301L including a plurality of lenses, reflecting mirrors, and the like, and a lens system control circuit 303. The right optical system 301R includes a lens 302R disposed near the object, and the left optical system 301L includes a lens 302L disposed near the object. The lens 302R and the lens 302L are oriented in the same direction and optical axes thereof are substantially parallel to each other.

The lens unit 300 is a dual-lens unit (VR180 lens unit) for obtaining a VR180 image that is one of virtual reality (VR) image formats capable of binocular stereoscopic vision. In the lens unit 300, each of the right optical system 301R and the left optical system 301L includes a fish-eye lens capable of capturing a range of about 180 degrees. Note that, the range that can be captured by the lens of each of the right optical system 301R and the left optical system 301L may be a range of about 160 degrees, which is narrower than the range of 180 degrees. The lens unit 300 can form a right image formed through the right optical system 301R and a left image formed through the left optical system 301L on one or two imaging elements of the camera to which the lens unit 300 is mounted. In the camera 100, the right image and the left image are formed on one imaging element (image sensor), and one image (binocular image) in which a right image area (area of right image) and a left image area (area of left image) are arranged side by side is generated. Note that an image to be the right image area and an image to be the left image area may be generated.

The lens unit 300 is mounted to the camera 100 via a lens mount portion 304 and a camera mount portion 305 of the camera 100. In this manner, the system control unit 50 of the camera 100 and the lens system control circuit 303 of the lens unit 300 are thus electrically connected to each other via the communication terminal 124 of the camera 100 and a communication terminal 306 of the lens unit 300. A right drive unit 307R changes the focal position of the right optical system 301R by moving the right optical system 301R in the optical axis direction on the basis of the instruction of the driving amount from the lens system control circuit 303. A left drive unit 307L changes the focal position of the left optical system 301L by moving the left optical system 301L in the optical axis direction on the basis of the instruction of the driving amount from the lens system control circuit 303.

Here, problems to be solved in the present embodiment will be described. In the right image area and the left image area described above, the angle of view (range) to be imaged differs depending on the parallax, and the position of the object differs. Then, even if the distance from the camera 100 to the object is the same, in the image captured using a fish-eye lens or the like, the focal position at which the object is in focus varies depending on the position in the image. For example, the focal position is different between the central portion and the end portion of the image. Therefore, in a case where the focal position of the right optical system 301R and the focal position of the left optical system 301L are the same, the focusing degree of the same object (for example, the main object) may be different between the right image area and the left image area.

Japanese Patent Laid-Open No. 2013-109079 discloses a technology for adjusting a relative position of a focus evaluation area in one of two images and a relative position of a focus evaluation area in the other of the two images based on a separation distance between two optical systems. In the technology disclosed in Japanese Patent Laid-Open No. 2013-109079, two optical systems are individually driven. However, the difference between the position of the object in the right image area and the position of the object in the left image area depends on the distance from the camera 100 to the object. Therefore, even if the separation distance between the right optical system 301R and the left optical system 301L is used (the technology disclosed in Japanese Patent Laid-Open No. 2013-109079 may be used), the two focus evaluation areas may not be set so as to match the object in the right image area and the object in the left image area, respectively. As a result, the focusing degree of the same object (for example, the main object) may be different between the right image area and the left image area.

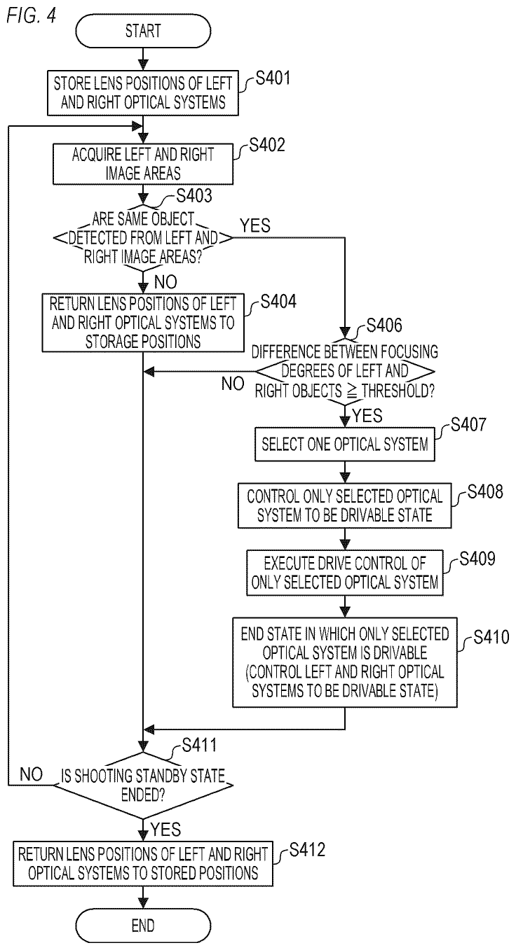

FIG. 4 is a flowchart illustrating an example of an operation of the camera 100. The operation is implemented by loading a program recorded in the nonvolatile memory 219 into the system memory 218 and executing the program by the system control unit 50. The operation of FIG. 4 is performed in the shooting standby state of the camera 100 (during display of the shooting standby screen). For example, when the camera 100 is activated in the shooting mode or the shooting mode is set to the camera 100, the operation of FIG. 4 is started.

In S401, the system control unit 50 stores information on the lens position of the right optical system 301R and the lens position of the left optical system 301L in the memory 215 via the memory control unit 213. The lens position is a relative position of the lens in the camera 100, and may be interpreted as a focal position of the optical system, a focal length of the optical system, a distance from the imaging unit 211 to the lens in a direction perpendicular to the imaging surface of the imaging unit 211 (front direction of the camera 100), or the like.

At the timing of S401, the driving states of the right optical system 301R and the left optical system 301L are states in which the right optical system 301R and the left optical system 301L can be individually or simultaneously driven. Then, in this driving state, when at least one of the lens position of the right optical system 301R and the lens position of the left optical system 301L is changed, the information stored in the memory 215 is updated. The drive control of the right optical system 301R and the left optical system 301L may be performed automatically or may be performed manually (according to a user operation). For example, the drive control of the right optical system 301R is performed so as to focus on the central portion of the right image area, and the drive control of the left optical system 301L is performed so as to focus on the central portion of the left image area. The drive control of the right optical system 301R and the left optical system 301L may be performed using the technology disclosed in Japanese Patent Laid-Open No. 2013-109079.

In S402, the system control unit 50 stores the captured image obtained by the imaging unit 211 and converted into digital data by the A/D converter 212 in the memory 215 via the memory control unit 213. Here, it is assumed that a captured image including a right image area captured via the right optical system 301R and a left image area captured via the left optical system 301L is acquired.

In S403, the system control unit 50 acquires the captured images (the right image area and the left image area in the captured image) stored in S402 from the memory 215 via the memory control unit 213, and detects the object from each of the right image area and the left image area. Then, the system control unit 50 determines whether the same object is detected from the right image area and the left image area. In a case where the system control unit 50 determines that the same object is detected, the processing proceeds to step S406, and otherwise, the processing proceeds to step S404.

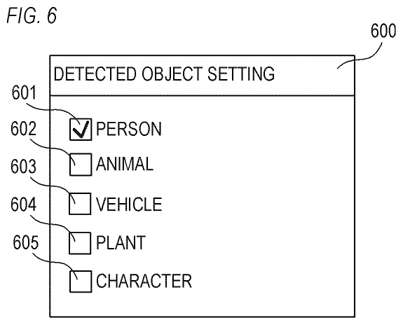

FIG. 6 is a schematic diagram illustrating an example of a setting screen for setting an object (type of object) to be detected. The setting screen 600 includes selection items 601 to 605, and the user can select at least one of the selection items 601 to 605. The system control unit 50 sets a person as an object to be detected in a case where the selection item 601 is selected, sets an animal as an object to be detected in a case where the selection item 602 is selected, and sets a vehicle as an object to be detected in a case where the selection item 603 is selected. The system control unit 50 sets a plant as the object to be detected in a case where the selection item 604 is selected, and sets a character as the object to be detected in a case where the selection item 605 is selected. In a case where none of the selection items 601 to 605 is selected, the system control unit 50 sets not to perform object detection. The setting information of the object to be detected is stored in a nonvolatile memory 56. In S403, the system control unit 50 acquires setting information of the object to be detected from the nonvolatile memory 56, and detects the object to be detected from the right image area and the left image area.

Note that a method of detecting the object is not particularly limited, and various proposed methods may be used. The object to be detected may be a specific person or the like. When the object to be detected is a person and a plurality of persons are detected from one image area, the system control unit 50 may determine whether the same object is detected from the right image area and the left image area by regarding the plurality of persons (group of persons) as one object. When a group of persons is detected from each of the right image area and the left image area, the system control unit 50 may calculate a matching degree between the group of persons detected from the right image area and the group of persons detected from the left image area. Then, the system control unit 50 may determine that the same object has been detected in a case where the matching degree is a predetermined threshold or more, and may determine that the same object has not been detected in a case where the matching degree is less than the predetermined threshold.

In S404, the system control unit 50 acquires information on the lens position of the right optical system 301R and the lens position of the left optical system 301L from the memory 215 via the memory control unit 213. Then, the system control unit 50 performs drive control of the right optical system 301R and the left optical system 301L such that the lens position of the right optical system 301R and the lens position of the left optical system 301L coincide with the lens position indicated by the above information. For example, the system control unit 50 calculates the driving amount of the right optical system 301R and the driving amount of the left optical system 301L such that the lens position of the right optical system 301R and the lens position of the left optical system 301L coincide with the lens position indicated by the above information. Then, the system control unit 50 instructs the right optical system 301R and the left drive unit 307L on the calculated driving amount. The right drive unit 307R drives the right optical system 301R by the driving amount instructed from the system control unit 50, and the left drive unit 307L drives the left optical system 301L by the driving amount instructed from the system control unit 50. At the timing of S404, similarly to the timing of S401, the driving states of the right optical system 301R and the left optical system 301L are states in which the right optical system 301R and the left optical system 301L can be individually or simultaneously driven.

In S406, the system control unit 50 acquires the focusing degree of the object (object in the right image area and object in the left image area) determined to be the same in S403. Then, the system control unit 50 determines whether a difference between the acquired two focusing degrees (focusing degree of the object in the right image area and focusing degree of the object in the left image area) is equal to or greater than a predetermined threshold. If the system control unit 50 determines that the difference is equal to or greater than the predetermined threshold, the processing proceeds to S407, and if not, the processing proceeds to S411. Note that a method of acquiring the focusing degree is not particularly limited, and various proposed methods may be used.

In S407, the system control unit 50 selects an optical system to be drivable from the right optical system 301R and the left optical system 301L, and stores information of the selected optical system in the memory 215 via the memory control unit 213. For example, the system control unit 50 selects an optical system corresponding to an image area having a lower focusing degree of the object (the focusing degree acquired in S406) between the right image area and the left image area. The optical system to be drivable may be an optical system selected in advance by the user (an optical system set in advance according to an instruction from the user).

In S408, the system control unit 50 acquires information of the optical system to be drivable (the optical system selected in S407) from the memory 215 via the memory control unit 213. Then, the system control unit 50 controls the driving states of the right optical system 301R and the left optical system 301L such that only one of the right optical system 301R and the left optical system 301L (the optical system indicated by the above information) can be driven.

In S409, the system control unit 50 performs drive control of only the drivable optical system (the optical system made drivable in S408) out of the right optical system 301R and the left optical system 301L. Here, the drive control of the optical system may be performed manually (according to a user operation) or automatically. For example, the drive control of the optical system is performed such that a difference between the focusing degree of the object in the right image area and the focusing degree of the object in the left image area is reduced.

In S410, the system control unit 50 ends the state in which only one of the right optical system 301R and the left optical system 301L can be driven, and controls the driving states of the right optical system 301R and the left optical system 301L such that the right optical system 301R and the left optical system 301L can be individually or simultaneously driven.

In step S411, the system control unit 50 determines whether to end the shooting standby state (display of shooting standby screen, shooting mode). In a case where the system control unit 50 determines to end the shooting standby state, the processing proceeds to S412, and otherwise, the processing proceeds to step S402. For example, the system control unit 50 determines to end the shooting standby state when a user operation of switching the operation mode of the camera 100 to an operation mode different from the shooting mode or a user operation of turning off the power of the camera 100 is performed.

In S412, the system control unit 50 acquires information on the lens position of the right optical system 301R and the lens position of the left optical system 301L from the memory 215 via the memory control unit 213. Then, the system control unit 50 performs drive control of the right optical system 301R and the left optical system 301L such that the lens position of the right optical system 301R and the lens position of the left optical system 301L coincide with the lens position indicated by the above information.

As described above, according to the present embodiment, the same object is detected from the right image area and the left image area, and the focusing degree of the object in the right image area and the focusing degree of the object in the left image area are acquired. Then, in a case where the difference between the focusing degrees is larger than a predetermined threshold, the driving states of the right optical system 301R and the left optical system 301L are controlled from a state in which the right optical system 301R and the left optical system 301L can be driven to a state in which only one of the right optical system 301R and the left optical system 301L can be driven. In this way, it is possible to efficiently perform focus control (drive) of the right optical system 301R and the left optical system 301L so that an image capable of favorable stereoscopic vision can be generated. For example, the focus control of the right optical system 301R and the left optical system 301L can be efficiently performed so as to focus on the same object in the right image area and the left image area.

In addition, according to the present embodiment, information on the lens position of the right optical system 301R and the lens position of the left optical system 301L before controlling only one of the right optical system 301R and the left optical system 301L to a drivable state is recorded in the storage unit (S401). When the predetermined mode is ended (YES in S411), the lens position of right optical system 301R and the lens position of left optical system 301L are controlled to the lens position indicated by the above information (S412). Also in a case where the object determined to be the same is not detected from at least one of the right image area and the left image area (NO in S403), the lens position of the right optical system 301R and the lens position of the left optical system 301L are controlled to the lens position indicated by the above information (S404). As a result, it is possible to omit the user from returning the lens position of the right optical system 301R and the lens position of the left optical system 301L to the original lens positions, and convenience can be improved. One or both of S404 and S412 may be omitted.

Note that, although the example of controlling the driving states of the right optical system 301R and the left optical system 301L has been described, in a case where the difference in the focusing degree is larger than a predetermined threshold, guidance recommending driving of only one of the right optical system 301R and the left optical system 301L may be displayed. Even with such guidance display, an effect equivalent to the effect of the present embodiment described above can be obtained.

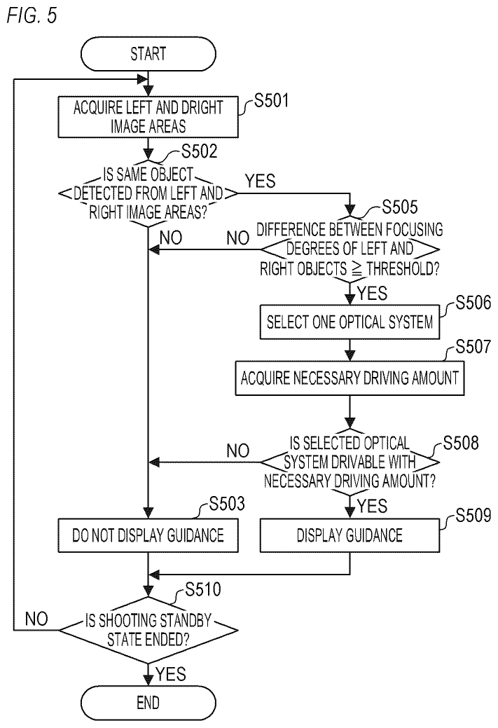

FIG. 5 is a flowchart illustrating another example of the operation of the camera 100. The operation is implemented by loading a program recorded in the nonvolatile memory 219 into the system memory 218 and executing the program by the system control unit 50. The operation of FIG. 5 is performed in the shooting standby state of the camera 100 (during display of the shooting standby screen). For example, when the camera 100 is activated in the shooting mode or the shooting mode is set to the camera 100, the operation of FIG. 5 is started.

In S501, similarly to S402, the system control unit 50 stores the captured image obtained by the imaging unit 211 and converted into digital data by the A/D converter 212 in the memory 215 via the memory control unit 213. Here, it is assumed that a captured image including a right image area captured via the right optical system 301R and a left image area captured via the left optical system 301L is acquired.

In S502, similarly to S403, the system control unit 50 acquires the captured image (the right image area and the left image area in the captured image) stored in S501 from the memory 215 via the memory control unit 213, and detects the object from each of the right image area and the left image area. Then, the system control unit 50 determines whether the same object is detected from the right image area and the left image area. In a case where the system control unit 50 determines that the same object is detected, the processing proceeds to step S505, and otherwise, the processing proceeds to step S503.

In S503, when the guidance recommending the driving of only one of the right optical system 301R and the left optical system 301L is displayed, the system control unit 50 performs control to hide the guidance. In this case, the guidance is not displayed, and a right image area, a left image area, a frame indicating the detected object, and the like are displayed.

In S505, similarly to S406, the system control unit 50 acquires the focusing degree of the object (object in the right image area and object in the left image area) determined to be the same in S502. Then, the system control unit 50 determines whether a difference between the acquired two focusing degrees (focusing degree of the object in the right image area and focusing degree of the object in the left image area) is equal to or greater than a predetermined threshold. If the system control unit 50 determines that the difference is equal to or greater than the predetermined threshold, the processing proceeds to S506, and if not, the processing proceeds to S503. In a case where it is determined that the difference is not the predetermined threshold or more, the processing proceeds to S503, and thus the control to display the guidance is not performed. When the processing proceeds to S506, the system control unit 50 stores the difference information in the memory 215 via the memory control unit 213.

In S506, the system control unit 50 selects an optical system to be driven from the right optical system 301R and the left optical system 301L, and stores information of the selected optical system in the memory 215 via the memory control unit 213. For example, the system control unit 50 selects an optical system corresponding to an image area having a lower focusing degree of the object (the focusing degree acquired in S505) between the right image area and the left image area. The optical system to be driven may be an optical system selected in advance by the user (an optical system set in advance according to an instruction from the user).

In S507, the system control unit 50 acquires, from the memory 215 via the memory control unit 213, the information on the difference in the focusing degree (the difference calculated in S505) and the information on the optical system to be driven (the optical system selected in S506). Then, based on the difference, the system control unit 50 acquires (calculates) a driving amount of the optical system to be driven, which is necessary for matching the focusing degree of the object in the right image area with the focusing degree of the object in the left image area. The system control unit 50 stores the acquired driving amount in the memory 215 via the memory control unit 213.

In S508, the system control unit 50 acquires information on the optical system to be driven (the optical system selected in S506) and information on the necessary driving amount (the driving amount acquired in S507) from the memory 215 via the memory control unit 213. Then, the system control unit 50 determines whether the optical system can be driven with a necessary driving amount within a drivable range of the optical system to be driven. In a case where the system control unit 50 determines that the optical system to be driven can be driven with a necessary driving amount, the processing proceeds to S509, and otherwise, the processing proceeds to S503. In a case where it is determined that the optical system to be driven cannot be driven with the necessary driving amount, the processing proceeds to S503, and thus the control to display the guidance is not performed. The drivable range of the right optical system 301R and the drive image range of the left optical system 301L are determined by the configuration of the lens unit 300.

Steps similar to steps S507 and S508 may be added to FIG. 4. For example, after S407, the system control unit 50 acquires a necessary driving amount of the optical system to be drivable (the optical system selected in S407) by the same method as S507. Then, the system control unit 50 determines whether the optical system to be drivable (the optical system selected in S407) can be driven with a necessary driving amount. In a case where the system control unit 50 determines that the optical system to be drivable can be driven with a necessary driving amount, the processing proceeds to S408, and otherwise, the processing proceeds to S411. As described above, when the optical system to be drivable cannot be driven with a necessary driving amount, the driving states of the right optical system 301R and the left optical system 301L may not be controlled to a state in which only one of the right optical system 301R and the left optical system 301L (the optical system selected in S407) can be driven. In other words, when the optical system to be drivable cannot be driven with a necessary driving amount, the driving states of the right optical system 301R and the left optical system 301L may be maintained in a state where the right optical system 301R and the left optical system 301L can be individually or simultaneously driven.

In S509, the system control unit 50 performs control to display, on the display unit 108, the guidance recommending driving of only the optical system to be driven (the optical system selected in S506).

In step S510, similarly to S411, the system control unit 50 determines whether to end the shooting standby state (display of shooting standby screen or shooting mode). In a case where the system control unit 50 determines to end the shooting standby state, the operation of FIG. 5 is ended, and otherwise, the processing proceeds to step S501.

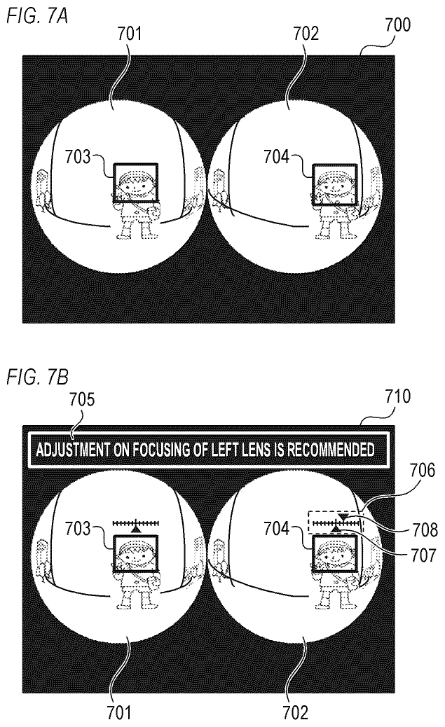

FIGS. 7A and 7B are schematic diagrams illustrating an example of the shooting standby screen. A shooting standby screen 700 in FIG. 7A is a shooting standby screen in a state where the guidance is not displayed. On the shooting standby screen 700, a right image area 701 and a left image area 702 are displayed. Here, it is assumed that the same object (person) is detected from the right image area 701 and the left image area 702. A frame 703 surrounding the object detected from the right image area 701 is superimposed on the right image area 701, and a frame 704 surrounding the object detected from the left image area 702 is superimposed on the left image area 702. The shooting standby screen 710 in FIG. 7B is a shooting standby screen on which guidance 705 and 706 recommending the driving of the left optical system 301L are displayed. The guidance 705 is a text that recommends driving of the left optical system 301L. The guidance 706 is guidance that can identify which focal position of the right optical system 301R and the left optical system 301L should be controlled in which direction and by what amount. Since the guidance 706 (indicator 708 to be described later) is displayed in the left image area 702, the user can grasp that the focal position of the left optical system 301L should be controlled. The guidance 706 includes an indicator 707 indicating the focal position of the left optical system 301L and an indicator 708 indicating the target position of the focal position of the left optical system 301L (focal position of the right optical system 301R). From the positional relationship between the indicator 707 and the indicator 708, the user can grasp in which direction and by what amount the focal position of left optical system 301L should be controlled.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

Furthermore, in the above-described embodiment, a case where the present disclosure is applied to the digital camera (imaging apparatus) is described as an example, but the present disclosure is not limited to the example, and any electronic device capable of controlling the driving state of an optical system is applicable. For example, the present disclosure can be applied to a personal computer, a PDA, a mobile phone terminal, a portable image viewer, a printer apparatus, a digital photo frame, a music player, a game machine, an electronic book reader, and the like. Also, the present disclosure can be applied to a video player, a display device (including a projection device), a tablet terminal, a smartphone, an AI speaker, a home electric appliance, an in-vehicle apparatus, and the like.

Also, the present disclosure can be applied not only to a main device of the imaging apparatus but also to a control apparatus that communicates with an imaging apparatus (including a network camera) via wired or wireless communication to remotely control the imaging apparatus. Examples of an apparatus that remotely controls the imaging apparatus include devices such as a smartphone, a tablet PC, and a desktop PC. The imaging apparatus can be controlled remotely by notifying the imaging apparatus of a command from the control apparatus side that causes the apparatus to perform various operations and settings based on an operation performed on the control apparatus side or a process performed on the control apparatus side. A live view image shot by the imaging apparatus may be received via wired or wireless communication and may be displayed on the control apparatus side.

According to the present disclosure, it is possible to reduce the possibility of generating an image that is difficult to stereoscopically view and to improve user experience.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024362, filed Feb. 18, 2025, which is hereby incorporated by reference herein in its entirety.

What is claimed is:

1. An electronic device comprising:
a processor; and
a memory storing a program which, when executed by the processor, causes the electronic device to
execute first acquisition processing of acquiring a first image area captured via a first optical system and a second image area captured via a second optical system;
execute detection processing of detecting a same object from the first image area and the second image area;
execute second acquisition processing of acquiring a first focusing degree that is a focusing degree of the object in the first image area and a second focusing degree that is a focusing degree of the object in the second image area; and
execute, in a case where a difference between the first focusing degree and the second focusing degree is larger than a predetermined threshold, control processing of controlling driving states of the first optical system and the second optical system from a first state in which the first optical system and the second optical system are able to be driven to a second state in which only one of the first optical system and the second optical system is able to be driven.

2. The electronic device according to claim 1, wherein
the one optical system is an optical system corresponding to an image area having a lower focusing degree of the object, of the first image area and the second image area.

3. The electronic device according to claim 1, wherein
the one optical system is an optical system selected in advance by a user from the first optical system and the second optical system.

4. The electronic device according to claim 1, wherein
in the control processing, drive control of the one optical system is automatically performed such that a difference between the first focusing degree and the second focusing degree is reduced in the second state.

5. The electronic device according to claim 1, wherein
in the control processing, drive control of the one optical system is performed according to a user operation in the second state.

6. The electronic device according to claim 1, wherein
when the program is executed by the processor, the program further causes the electronic device to execute setting processing of setting the object to be detected by the detection processing, according to a user operation.

7. The electronic device according to claim 1, wherein
when the program is executed by the processor, the program further causes the electronic device to execute recording processing of recording information of a lens position of the first optical system and a lens position of the second optical system in a storage before a driving state between the first optical system and the second optical system is controlled from the first state to the second state,
control of the driving states of the first optical system and the second optical system from the first state to the second state is performed in a predetermined mode, and
in at least one of a case where the predetermined mode is ended and a case where the object is no longer detected from at least one of the first image area and the second image area, in the control processing, a lens position of the first optical system and a lens position of the second optical system are controlled to lens positions before a driving state between the first optical system and the second optical system is controlled from the first state to the second state, based on the information recorded in the storage.

8. The electronic device according to claim 1, wherein
when the program is executed by the processor, the program further causes the electronic device to execute third acquisition processing of acquiring a driving amount of the one optical system necessary for matching the first focusing degree and the second focusing degree based on a difference between the first focusing degree and the second focusing degree, and
in a case where the one optical system is not able to be driven by the driving amount acquired by the third acquisition processing, in the control processing, the driving states of the first optical system and the second optical system are not controlled from the first state to the second state.

9. The electronic device according to claim 1, wherein
in the first acquisition processing, an image including the first image area and the second image area is acquired.

10. The electronic device according to claim 9, wherein
the image is generated by forming the first image area and the second image area on one imaging element.

11. The electronic device according to claim 1, wherein
the first image area is an image having a predetermined parallax with respect to the second image area.

12. An electronic device comprising:
a processor; and
a memory storing a program which, when executed by the processor, causes the electronic device to
execute first acquisition processing of acquiring a first image area captured via a first optical system and a second image area captured via a second optical system;
execute detection processing of detecting a same object from the first image area and the second image area;
execute second acquisition processing of acquiring a first focusing degree that is a focusing degree of the object in the first image area and a second focusing degree that is a focusing degree of the object in the second image area; and
execute, in a case where a difference between the first focusing degree and the second focusing degree is larger than a predetermined threshold, display control processing of performing control so as to display guidance recommending driving of only one optical system of the first optical system and the second optical system.

13. The electronic device according to claim 12, wherein
by the guidance, it is possible to identify which focal position of the first optical system and the second optical system is to be controlled in which direction and by what amount.

14. The electronic device according to claim 12, wherein
when the program is executed by the processor, the program further causes the electronic device to execute third acquisition processing of acquiring a driving amount of the one optical system necessary for matching the first focusing degree and the second focusing degree based on a difference between the first focusing degree and the second focusing degree, and
in a case where the one optical system is not able to be driven by the driving amount acquired by the third acquisition processing, control of displaying the guidance is not performed in the display control processing.

15. The electronic device according to claim 12, wherein
in the first acquisition processing, an image including the first image area and the second image area is acquired.

16. The electronic device according to claim 15, wherein
the image is generated by forming the first image area and the second image area on one imaging element.

17. The electronic device according to claim 12, wherein
the first image area is an image having a predetermined parallax with respect to the second image area.

18. A control method of an electronic device, comprising:
acquiring a first image area captured via a first optical system and a second image area captured via a second optical system;
detecting a same object from the first image area and the second image area;
acquiring a first focusing degree that is a focusing degree of the object in the first image area and a second focusing degree that is a focusing degree of the object in the second image area; and
in a case where a difference between the first focusing degree and the second focusing degree is larger than a predetermined threshold, controlling driving states of the first optical system and the second optical system from a first state in which the first optical system and the second optical system are able to be driven to a second state in which only one of the first optical system and the second optical system is able to be driven.

19. A non-transitory computer readable medium that stores a program, wherein the program causes a computer to execute a control method according to claim 18.
